(19) United States
(12) Patent Application Publication
(10) Pub. No.: US 2015/0199707 A1
(43) Pub. Date: Jul. 16, 2015

(54) PRIVILEGE INFORMATION PROCESSING SYSTEM, METHOD FOR PROCESSING PRIVILEGE INFORMATION, AND INFORMATION PROCESSING APPARATUS

(71) Applicants: Junichi Ono, Tokyo (JP); Mikihito Asai, Tokyo (JP)

(72) Inventors: Junichi Ono, Tokyo (JP); Mikihito Asai, Tokyo (JP)

(73) Assignee: RICOH COMPANY, LTD., Tokyo (JP)

(21) Appl. No.: 14/590,095

(22) Filed: Jan. 6, 2015

(30) Foreign Application Priority Data
Jan. 16, 2014 (JP) 2014-005974

(51) Int. Cl. G06Q 30/02; G06Q 30/06

(52) U.S. Cl. CPC G06Q 30/0239; G06Q 30/0641

(57) ABSTRACT

A system includes an acquisition unit configured to acquire browsing history information on a website in an online shopping service; an analyzer configured to quantify a browsing act on the website by a user of the service based on the acquired information; and a notification generator configured to generate information for notifying of a privilege granted to the user in the service based on the quantified browsing act. The browsing history information includes user identification of the service, item identification of an item sold in the service, and act identification of the type of the browsing act on the website. The analyzer extracts the browsing history information based on the user identification and the item identification, and quantify the browsing act on the website by referring to information set with a numerical value appropriate for the browsing act on the website based on the act identification.

### CROSS-REFERENCE TO RELATED APPLICATION

The present application claims priority to and incorporates by reference the entire contents of Japanese Patent Application No. 2014-005974 filed in Japan on Jan. 16, 2014.

### BACKGROUND OF THE INVENTION

1. Field of the Invention

The present invention relates to a privilege information processing system, a method for processing privilege information, and an information processing apparatus.

2. Description of the Related Art

Online shopping services that sell and purchase items via network lines such as the Internet are generally widely used. For sales promotion, granting points appropriate for purchase amounts of items, item recommendation systems appropriate for item purchasing and browsing histories, or the like are used. In order to increase the effect of sales promotion for specific items, a system is developed that discounts necessary points at the time of purchasing items using points based on purchasing contribution calculated in accordance with purchase histories of customers (refer to Japanese Laid-open Patent Publication No. 2004-287874, for example).

### SUMMARY OF THE INVENTION

It is an object of the present invention to at least partially solve the problems in the conventional technology.

According to an embodiment, there is provided a privilege information processing system for managing privileges granted in an online shopping service that sells items via a network. The privilege information processing system includes a browsing history information acquisition unit configured to acquire browsing history information on a website in the online shopping service; an information analyzer configured to quantify a browsing act on the website by a user of the online shopping service based on the acquired browsing history information; and a notification information generator configured to generate information for notifying of a privilege granted to the user in the online shopping service based on the quantified browsing act. The browsing history information includes user identification information for identifying a user of the online shopping service, item identification information for identifying an item sold in the online shopping service, and act identification information for identifying the type of the browsing act on the website. The information analyzer is configured to extract the browsing history information based on the user identification information and the item identification information included in the browsing history information, and quantify the browsing act on the website by referring to numerical value setting information set with a numerical value appropriate for the browsing act on the website based on the act identification information in the extracted browsing history information.

According to another embodiment, there is provided a method for processing privilege information that manages privileges granted in an online shopping service that sells items via a network. The method includes acquiring browsing history information on a website in the online shopping service as information comprising user identification information for identifying a user of the online shopping service, item identification information for identifying an item sold in the online shopping service, and act identification information for identifying the type of a browsing act on the website; extracting the browsing history information based on the user identification information and the item identification information included in the acquired browsing history information; quantifying the browsing act on the website by referring to numerical value setting information set with a numerical value appropriate for the browsing act on the website based on the act identification information in the extracted browsing history information; and generating information for notifying of a privilege to be granted to the user in the online shopping service based on the quantified browsing act.

According to still another embodiment, there is provided an information processing apparatus for managing privileges granted in an online shopping service that sells items via a network. The information processing apparatus includes a browsing history information acquisition unit configured to acquire browsing history information on a website in the online shopping service; an information analyzer configured to quantify a browsing act on the website by a user of the online shopping service based on the acquired browsing history information; and a notification information generator configured to generate information for notifying of a privilege granted to the user in the online shopping service based on the quantified browsing act. The browsing history information includes user identification information for identifying a user of the online shopping service, item identification information for identifying an item sold in the online shopping service, and act identification information for identifying the type of the browsing act on the website. The information analyzer is configured to extract the browsing history information based on the user identification information and the item identification information included in the browsing history information, and quantify the browsing act on the website by referring to numerical value setting information set with a numerical value appropriate for the browsing act on the website based on the act identification information in the extracted browsing history information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an operation form of a system according to an embodiment of the present invention;

FIG. 2 is a block diagram illustrating the hardware configuration of an information processing apparatus according to the embodiment of the present invention;

FIG. 3 is a flowchart illustrating the operation of the entire system according to the embodiment of the present invention;

FIG. 4 is a block diagram illustrating the functional configuration of a shop server according to the embodiment of the present invention;

FIG. 5 is a diagram illustrating an example of a customer database (DB) according to the embodiment of the present invention;

FIG. 6 is a diagram illustrating an example of an item DB according to the embodiment of the present invention;

FIG. 7 is a diagram illustrating an example of a purchase history DB according to the embodiment of the present invention;

FIG. 8 is a block diagram illustrating the functional configuration of a privilege management server according to the embodiment of the present invention;

FIG. 9 is a diagram illustrating an example of an act history DB according to the embodiment of the present invention;

FIG. 10 is a diagram illustrating an example of a point DB according to the embodiment of the present invention;

FIG. 11 is a diagram illustrating an example of a threshold DB according to the embodiment of the present invention;

FIG. 12 is a diagram illustrating an example of a coefficient DB according to the embodiment of the present invention;

FIG. 13 is diagram illustrating an example of a privilege DB according to the embodiment of the present invention;

FIG. 14 is a flowchart illustrating an information analysis operation according to the embodiment of the present invention;

FIG. 15 is a flowchart illustrating a threshold determining operation according to the embodiment of the present invention;

FIG. 16 is a diagram illustrating an example of threshold comparison information according to the embodiment of the present invention;

FIG. 17 is a flowchart illustrating a privilege information updating operation according to the embodiment of the present invention;

FIG. 18 is a diagram illustrating privilege status information according to the embodiment of the present invention;

FIG. 19 is a flowchart illustrating an operation for notifying users of privilege statuses according to the embodiment of the present invention;

FIG. 20 is a diagram illustrating an example of an e-mail for notifying of privilege statuses according to the embodiment of the present invention;

FIG. 21 is a flowchart illustrating the determination of starting analysis operations for notifying of privilege statuses according to the embodiment of the present invention; and

FIG. 22 is a diagram illustrating a mode of calculating a point total value for each customer identification (ID) and item ID according to the embodiment of the present invention.

### DETAILED DESCRIPTION OF THE PREFERRED EMBODIMENTS

The following describes an embodiment according to the present invention with reference to the accompanying drawings. The present embodiment describes a privilege information processing system that, in an online shopping service that sells items via the Internet, analyzes browsing acts, such as the browsing of item pages and comparison among items of the same type, of users as customers, and in accordance with its analysis result, grants privileges to the users, thereby performing sales promotion.

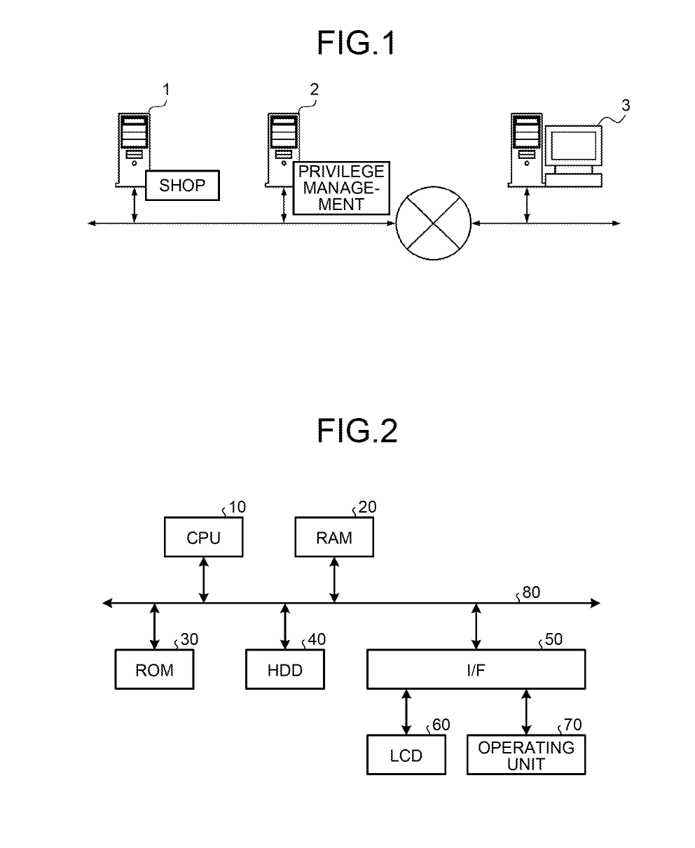

FIG. 1 is a diagram illustrating an operation form of an online shopping system according to the present embodiment. As illustrated in FIG. 1, the system according to the present embodiment includes a shop server 1, a privilege management server 2, and a personal computer (PC) 3 that are connected in a communicable manner via a network. The shop server 1 and the privilege management server 2 are connected to a network of a service provider. The network of the service provider and the PC 3 are connected via a public line such as the Internet.

The system according to the present embodiment is a system in which a user who does shopping does shopping by accessing a website provided by the shop server 1 via an information processing terminal such as the PC 3. The privilege management server 2 analyzes the exchange of information between the shop server 1 and the PC 3 in that situation, thereby causing the privilege management server 2 to grant a privilege to the user who operates the PC 3.

As illustrated in FIG. 1, the present embodiment describes a case, as an example, of providing a service by the shop server 1 and the privilege management server 2. In addition, there may be various modes by exchanging information via a network such as a mode in which the shop server 1 and the privilege management server 2 are combined and implemented in one server and another mode in which the functions of the respective servers are further distributed and implemented.

Described next with reference to FIG. 2 is the hardware configuration of an information processing apparatus such as the shop server 1, the privilege management server 2, and the PC 3 according to the present embodiment. As illustrated in FIG. 2, the information processing apparatus according to the present embodiment includes a similar configuration to that of general servers, PCs, or the like. Specifically, in the information processing apparatus according to the present embodiment, a central processing unit (CPU) 10, a random access memory (RAM) 20, a read only memory (ROM) 30, a hard disk drive (HDD) 40, and an interface (I/F) 50 are connected to each other via a bus 80. A liquid crystal display (LCD) 60 and an operating unit 70 are connected to the I/F 50.

The CPU 10 is an arithmetic unit and controls the operation of the entire information processing apparatus. The RAM 20 is a volatile storage medium capable of high-speed reading and writing of information and is used as a work area when the CPU 10 processes information. The ROM 30 is a read-only non-volatile storage medium and stores therein programs such as firmware. The HDD 40 is a non-volatile storage medium capable of reading and writing information and stores therein an operating system (OS), various control programs, application programs, or the like.

The I/F 50 connects the bus 80 and various hardware, networks, or the like and controls them. The LCD 60 is a visual user interface for a user to confirm the state of the information processing apparatus. The operating unit 70 is a user interface such as a keyboard and a mouse for a user to input information to the information processing apparatus. The shop server 1 and the privilege management server 2 according to the present embodiment are operated as servers that are not directly operated by a user, and the user interfaces such as the LCD 60 and the operating unit 70 can be omitted.

In such a hardware configuration, the CPU 10 performs arithmetic operations in accordance with the programs stored in the ROM 30 or programs loaded from the HDD 40 or a storage medium such as an optical disc (not illustrated) onto the RAM 20, thereby constituting a software controller. A combination of the thus constituted software controller and the hardware constitutes a functional block that implements the functions of the shop server 1, the privilege management server 2, and the PC 3 according to the present embodiment.

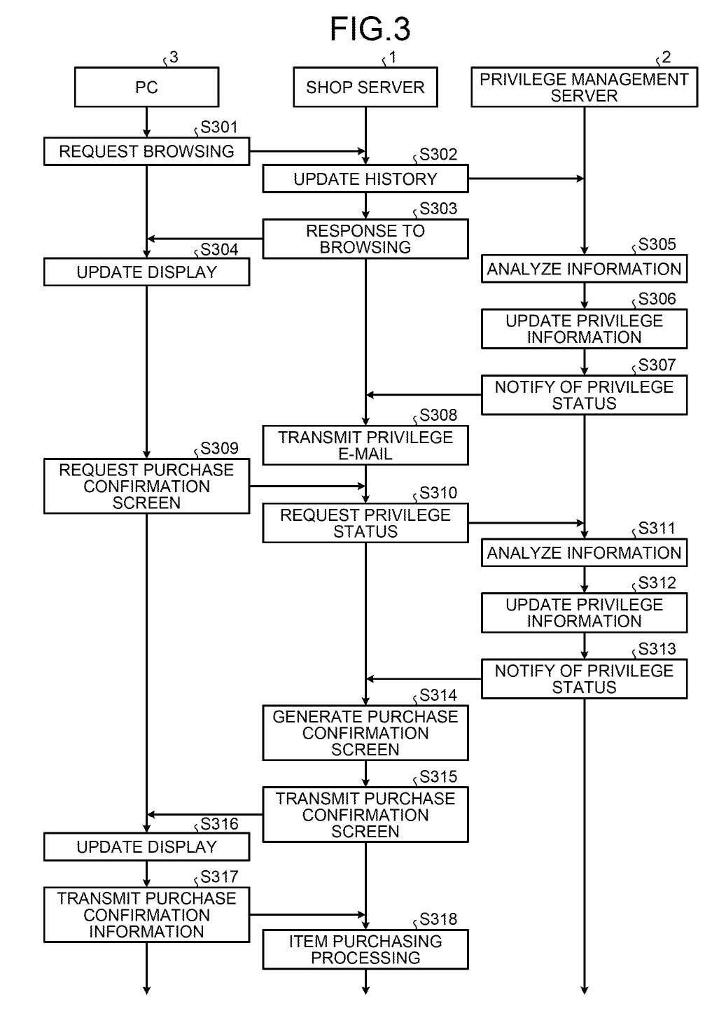

Next, the operation of the entire system according to the present embodiment will be described based on the sequence diagram in FIG. 3. The sequence diagram illustrated in FIG. 3 illustrates an operation in which a user uses the system according to the present embodiment does online shopping by accessing an online shopping website (hereinafter, referred to as a “shopping site”) provided by the shop server 1 via the PC 3, and the privilege management server 2 analyzes the exchange of information in that process, thereby determining the contents of a privilege to be granted and granting the privilege. As illustrated in FIG. 3, first, the PC 3 requests browsing from the shop server 1 in accordance with a browsing operation by the user (S301).

The browsing request at S301 includes browsing acts unique to the shopping site such as general browsing acts such as a request to display the top page of the shopping site provided by the shop server 1 and a request to display a specific item page, searching for items, and a request to display a comparison page that compares designated items. The browsing act on the shopping site is first started by accessing a top page uniform resource locator (URL) of the online shopping website provided by the shop server 1 through functions of a web browser as a software program installed in the PC 3, and for the second and the subsequent times, is performed by accessing a network address described in HyperText Markup Language (HTML) of the top page.

The shop server 1 that has received the browsing request from the PC 3 transmits information on the browsing request to the privilege management server 2, thereby updating act history information managed by the privilege management server 2 (S302) and performing a response appropriate for the request (S303). This response causes the PC 3 to update the display of the web browser in accordance with the requested browsing (S304). By repeating the pieces of processing at S301 to S304, online shopping is done, and the act history information is accumulated in the privilege management server 2.

The privilege management server 2 analyzes the accumulated act history information at certain timing (S305) and determines privileges to be granted to respective users. In the system according to the present embodiment, the privilege management server 2 determines browsing acts by turning them into points. A point (hereinafter, referred to as a “browsing point”) added by the browsing acts will be described in detail below.

The privilege management server 2 that has determined the privileges to be granted to the respective users updates privilege granting statuses of the respective users (S306) and notifies the shop server 1 of its result (S307). The shop server 1 that has received the notification of the privilege statuses from the privilege management server 2 transmits e-mails describing the current privilege statuses to the respective users (S308). This processing notifies the respective users of the current privilege statuses, thereby achieving a sales promotion effect.

By an operation on the PC 3 by a user, the PC 3 requests a purchase confirmation screen from the shop server 1 (S309). The purchase confirmation screen is a screen for determining the purchase of an item selected as an object to be purchased by the user by repeating the pieces of processing from S301 to S304. The shop server 1 that has received the request for the purchase confirmation screen notifies the privilege management server 2 of the user identification information of the user who requested the purchase confirmation screen and the item identification (ID) of the item to be purchased and requests a reply of a privilege status for the user concerned (S310).

The privilege management server 2 that has received the request for the privilege status analyzes the act history information accumulated by the processing at S302 in a similar manner to S305 (S311) and determines a privilege to be granted to the item concerned for the user concerned. The privilege management server 2 that has determined the privilege to be granted updates the privilege granting status of the user concerned (S312) and notifies the shop server 1 of its result (S313).

The shop server 1 that has received the notification of the privilege status generates a web page of the purchase confirmation screen reflecting the notified privilege status (S314) and transmits the web page as a response to the request for the purchase confirmation screen to the PC 3 (S315). This processing causes the PC 3 to display the purchase confirmation screen that displays the latest privilege status (S316).

The user performs a purchase confirmation operation on the thus displayed purchase confirmation screen, thereby causing the PC 3 to transmit purchase confirmation information to the shop server 1 (S317). The shop server 1 that has received the purchase confirmation information performs item purchasing processing such as the storage of the purchase confirmation information and an item order (S318). In this situation, the item purchasing processing is performed including the notified contents of the privilege at S313, thereby performing the purchasing processing with the contents of the privilege reflected. This processing completes the operation of the entire system according to the present embodiment.

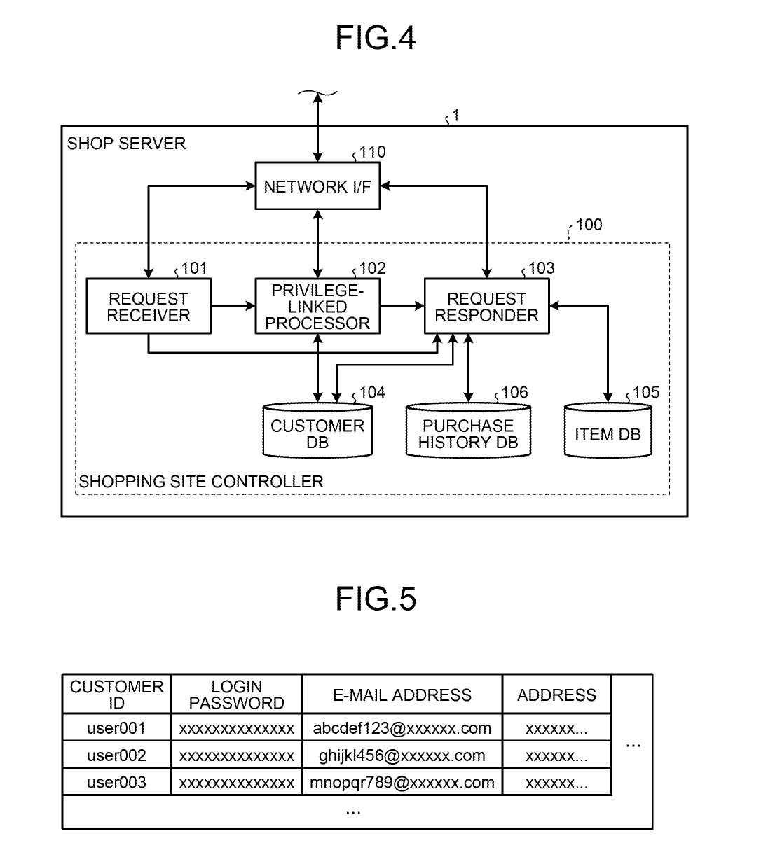

Next, information exchanged in the respective pieces of processing of the operation illustrated in FIG. 3 and functions for implementing the respective pieces of processing will be described. First, the functions of the shop server 1 will be described. FIG. 4 is a block diagram illustrating the functional configuration of the shop server 1 according to the present embodiment. As illustrated in FIG. 4, the shop server 1 according to the present embodiment includes a shopping site controller 100 and a network I/F 110. The shopping site controller 100 includes a request receiver 101, a privilege-linked processor 102, a request responder 103, a customer database (DB) 104, and item DB 105, and a purchase history DB 106.

The request receiver 101 accepts the browsing request from the PC 3 via the network I/F 110. Although a general website performs a response by the request responder 103 in response to the accepted browsing request, the request receiver 101 of the shopping site controller 100 according to the present embodiment inputs the accepted browsing request to the privilege-linked processor 102 and the request responder 103.

The privilege-linked processor 102 has functionality to be linked with the privilege management server 2 in the shop server 1. Specifically, when the browsing request is input from the request receiver 101, the privilege-linked processor 102 transmits the information to the privilege management server 2 via the network I/F 110, thereby performing processing to update the act history at S302.

When the request for the purchase confirmation screen is input from the request receiver 101, the privilege-linked processor 102 transmits the identification information of the user concerned and the identification information of the item concerned to the privilege management server 2 via the network I/F 110, thereby performing processing to request the privilege status illustrated at S310. Upon reception of information on the privilege status from the privilege management server 2 at S313, the privilege-linked processor 102 inputs the information together with a request to display the purchase confirmation screen to the request responder 103. In addition, upon reception of the information on the privilege status from the privilege management server 2 at S307, the privilege-linked processor 102 performs processing to transmit a privilege e-mail at S308.

The request responder 103 transmits information appropriate for the browsing request accepted by the request receiver 101 to the PC 3 via the network I/F 110 at S303. The information appropriate for the browsing request is, for example, information on a screen requested at a website, that is, information on a web page. In other words, the request responder functions as a web page generator. As described in FIG. 3, when the purchase confirmation screen is requested from the PC 3, the request responder 103 according to the present embodiment generates a purchase confirmation screen reflecting the privilege granting status analyzed and determined by the privilege management server 2 and transmits the purchase confirmation screen to the PC 3.

As illustrated in FIG. 5, the customer DB 104 is a database that manages information on users who use the shopping site. As illustrated in FIG. 5, the customer DB 104 includes pieces of information on “customer ID” as user identification information that identifies the respective users, “login password” for personally authenticating the respective users, “e-mail address” indicating the contact addresses of the respective users, and “address” of the respective users.

The customer information illustrated in FIG. 5 is used for authentication processing when a user logs into the shopping site or as information on delivery address upon determination of purchase. As described above, the system according to the present embodiment has functionality to notify the respective users of the privilege statuses determined by the privilege management server 2, in which the information illustrated in FIG. 5 is used as the addresses in that situation. Specifically, in FIG. 3, when transmitting the privilege e-mails to the respective users based on the privilege statuses of the respective users notified from the privilege management server 2 at S308, the privilege-linked processor 102 refers to the customer DB 104 to recognize the e-mail addresses of the respective users.

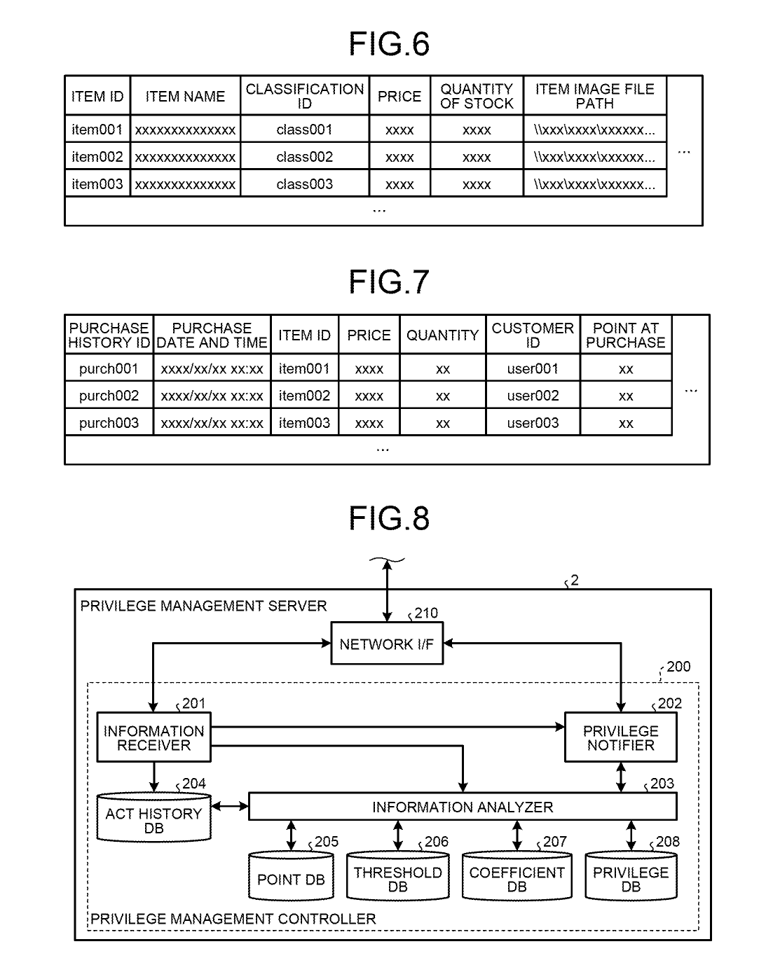

As illustrated in FIG. 6, the item DB 105 is a database that manages information on items sold at the shopping site. As illustrated in FIG. 6, the item DB 105 includes pieces of information on “item ID” as item identification information that identifies the respective items, “item name” indicating the names for sale of the respective items, “classification ID” that identifies the types of the respective items, “price” of the respective items, “quantity of stock” of the respective items, and “item image file path” indicating storage areas in which images of the respective items are stored.

As illustrated in FIG. 7, the purchase history DB 106 is a database that manages information on the sales history of items in the shopping sites. As illustrated in FIG. 7, the purchase history DB 106 includes pieces of information on “purchase history DB” that identifies respective purchase histories, “purchase date and time” indicating the dates and times of the respective purchase histories, “item ID” that identifies purchased items, “price” of the purchased items, “quantity” of the purchased items, “customer ID” that identifies users who purchased the respective items, and “point at purchase” indicating the browsing point at the time of item purchasing.

The pieces of information of the respective records of the purchase history DB 106 illustrated in FIG. 7 are generated by the request responder 103 and stored therein by the acceptance of the purchase confirmation information at S313 by the request receiver 101. Because of this processing, the purchase confirmation information at S317 includes at least “item ID,” “quantity,” and “customer ID.” “Purchase date and time” is determined based on the reception timing of the purchase confirmation information, whereas “price” is acquired by referring to the item DB 105 based on the notified “item ID.” “Point at purchase” is acquired as information notified from the privilege management server 2 at S313.

Next, the functionality of the privilege management server 2 will be described. FIG. 8 is a block diagram illustrating the functional configuration of the privilege management server 2 according to the present embodiment. As illustrated in FIG. 8, the privilege management server 2 according to the present embodiment includes a privilege management controller 200 and a network I/F 210. The privilege management controller 200 includes an information receiver 201, a privilege notifier 202, an information analyzer 203, an act history DB 204, a point DB 205, a threshold DB 206, a coefficient DB 207, and a privilege DB 208. A software program for constituting the privilege management controller 200 is used as a privilege information processing program.

The information receiver 201 acquires information received by the network I/F 210 via a network. For example, when receiving the request for updating the act history at S302 in FIG. 3, the information receiver 201 updates the information of the act history DB 204. When receiving the request for the privilege status at S310, the information receiver 201 inputs the request to the information analyzer 203 and causes it to perform the analysis of the information stored in the act history DB 204. In other words, the information receiver 201 functions as a browsing history information acquiring unit.

The privilege notifier 202 transmits the information on the privilege status determined by analyzing the information of the act history DB 204 by the information analyzer 203 to the shop server 1 via the network I/F 210 at S313 in FIG. 3. As described above, the privilege appropriate for the browsing act is managed by the point, and the privilege notifier 202 notifies of the browsing point together with the privilege status at S313.

The information analyzer 203 analyzes the information of the act history DB 204 based on the request for the privilege status from the shop server 1 and determines the privilege status to be granted to the user concerned at S311 in FIG. 3. In analyzing the information, the information analyzer 203 refers to, in addition to the information of the act history DB 204, the point DB 205, the threshold DB 206, the coefficient DB 207, and the privilege DB 208.

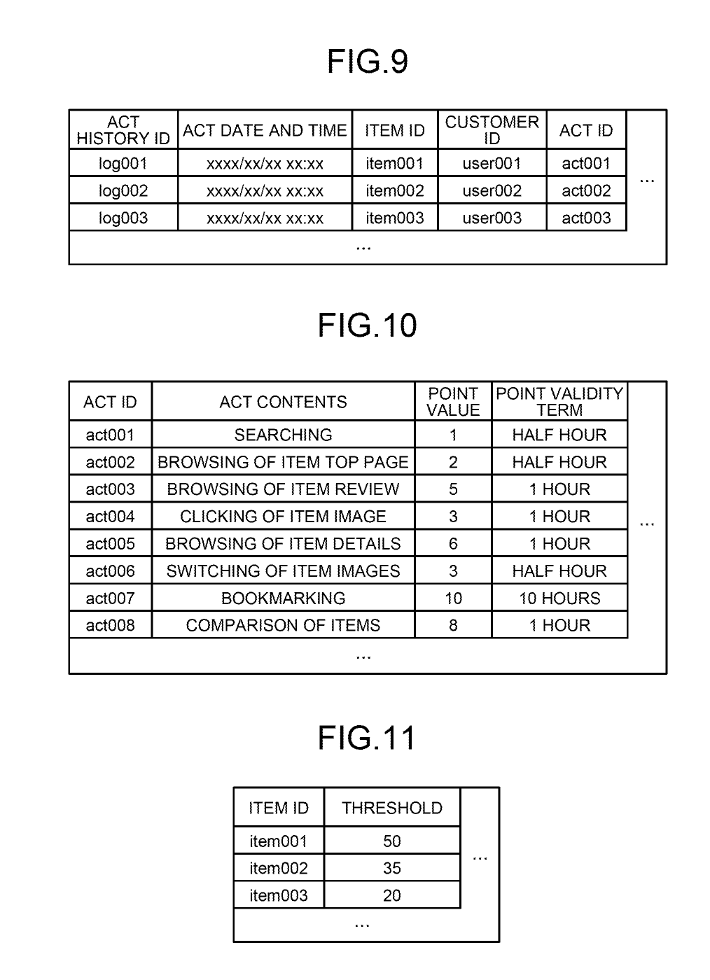

The act history DB 204 is a database in which the information accumulated by the processing at S302 in FIG. 3 is stored and managed. As illustrated in FIG. 9, the act history DB 204 includes pieces of information on “act history ID” that identifies respective act histories, “act date and time” as act timing information indicating the date and time of the respective acts, “item ID” that identifies items subjected to the browsing acts, “customer ID” that identifies users who performed the browsing acts, and “act ID” as act identification information that identifies detailed contents of the browsing acts.

The pieces of information of the respective records as illustrated in FIG. 9 are generated based on the information on the browsing request acquired by the information receiver 201 by the processing at S302. Because of this processing, the browsing request notified to the privilege management server 2 at S302 includes “item ID,” “customer ID,” and information for identifying the browsing acts. “Act date and time” is determined based on the acquisition timing of the browsing request, whereas “act ID” is determined by referring to the other DB based on the information for identifying the browsing acts.

The point DB 205 is a database that manages the browsing acts managed as the act history in the system according to the present embodiment, the contents of the respective acts, and the browsing point in association with each other. In other words, the point DB 205 is numerical value setting information set with numerical values appropriate for browsing acts on the online shopping website provided by the shop server 1. As illustrated in FIG. 10, the point DB 205 according to the present embodiment includes pieces of information on “act ID” for identifying the respective acts, “act contents” indicating the detailed contents of the respective acts, “point value” indicating the browsing points that are added by the respective acts, and “point validity term” indicating the validity term of the browsing points added by the respective acts.

“Act ID” described in FIG. 9 corresponds to “act ID” in FIG. 10. When generating the records illustrated in FIG. 9, the information receiver 201 refers to “act contents” in FIG. 10 based on the information for identifying the browsing acts and extracts “act ID” associated with the act contents concerned. “Point value” and “validity term” are referred to on the information analysis by the information analyzer 203 and are used for the calculation of the browsing point.

The threshold DB 206 is a database that sets and manages thresholds for the browsing point calculated as described above for each of the items managed by the item DB 105 described in FIG. 6. Although the information analyzer 203 determines the privilege to be granted in accordance with the browsing point calculated as described above, items have different selling prices and frequency in demand, and the application of a uniform threshold to all the items does not lead to efficient sales promotion.

As illustrated in FIG. 11, the system according to the present embodiment determines privilege granting appropriate for each of the items by managing “threshold” set for each “item ID” by the threshold DB 206, thereby achieving efficient sales promotion. “Item ID” in FIG. 11 corresponds to “item ID” described in FIG. 6.

The coefficient DB 207 is a database that sets and manages coefficients to be applied to the thresholds for the browsing point calculated as described above for each of the items managed by the item DB 105 illustrated in FIG. 6. As described below, the privileges according to the present embodiment have various types, and privileges to be granted are determined in accordance with the calculated browsing point.

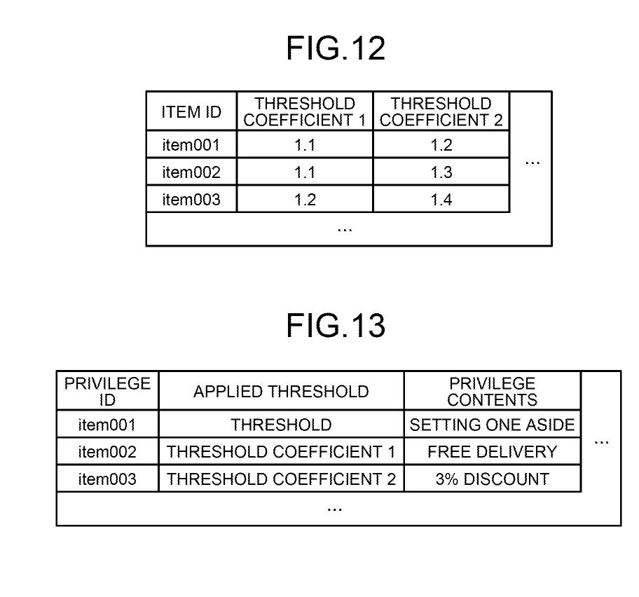

In view of the above, as illustrated in FIG. 12, the system according to the present embodiment manages “threshold coefficient 1” and “threshold coefficient 2” for each “item ID” by the coefficient DB 207, thereby enabling multi-stage threshold determination for each of the items. “Item ID” in FIG. 12 corresponds to “item ID” described in FIG. 6.

The privilege DB 208 is a database that manages privileges to be granted in accordance with the browsing act in the system according to the present embodiment. As described above, the system according to the present embodiment grants various types of privileges by the multi-stage threshold determination. For this purpose, as illustrated in FIG. 13, the privilege DB 208 includes pieced of information on “privilege ID” that identifies the respective privileges, “applied threshold” that is applied to the browsing point as conditions for granting the respective privileges, and “privilege contents” indicating the contents of the respective privileges.

By referring to the pieces of information in FIG. 11, FIG. 12, and FIG. 13, the thresholds as conditions for granting the respective privileges with respect to the respective items can be confirmed. For example, when confirming a condition for granting a privilege of “setting one aside” with respect to the item “item 001,” the information analyzer 203 first refers to the privilege DB 208 in FIG. 13 and confirms “applied threshold” corresponding to “setting one aside” to obtain “threshold.” The information analyzer 203 then refers to the threshold DB 206 illustrated in FIG. 11 based on the “threshold” and confirms “threshold” corresponding to “item 001” to obtain “50.”

When confirming a condition for granting a privilege of “free delivery” with respect to the item “item 001,” the information analyzer 203 first refers to the privilege DB 208 in FIG. 13 and confirms “applied threshold” corresponding to “free delivery” to obtain “threshold coefficient 1.” The information analyzer 203 then refers to the threshold DB 206 illustrated in FIG. 11 and confirms “threshold” corresponding to “item 001” to obtain “50” and refers to the coefficient DB 207 illustrated in FIG. 12 and confirms “threshold coefficient 1” corresponding to “item 001” based on the “threshold coefficient 1” acquired from the privilege DB 208 to obtain “1.1.”

The information analyzer 203 multiplies “50” by “1.1” to obtain a threshold corresponding to “threshold coefficient 1” of “item 001.” Thus, the pieces of information of the threshold DB 206 illustrated in FIG. 11, the coefficient DB 207 illustrated in FIG. 12, and the privilege DB 208 illustrated in FIG. 13 are used as threshold information set with the respective privileges and the thresholds as the conditions for granting the respective privileges.

The present embodiment sets “threshold” as a reference and a coefficient that multiplies it, thereby enabling the setting of different thresholds for the different privileges. However, this setting is an example, and a plurality of thresholds such as “threshold 1,” “threshold 2,” and “threshold 3” may be individually set.

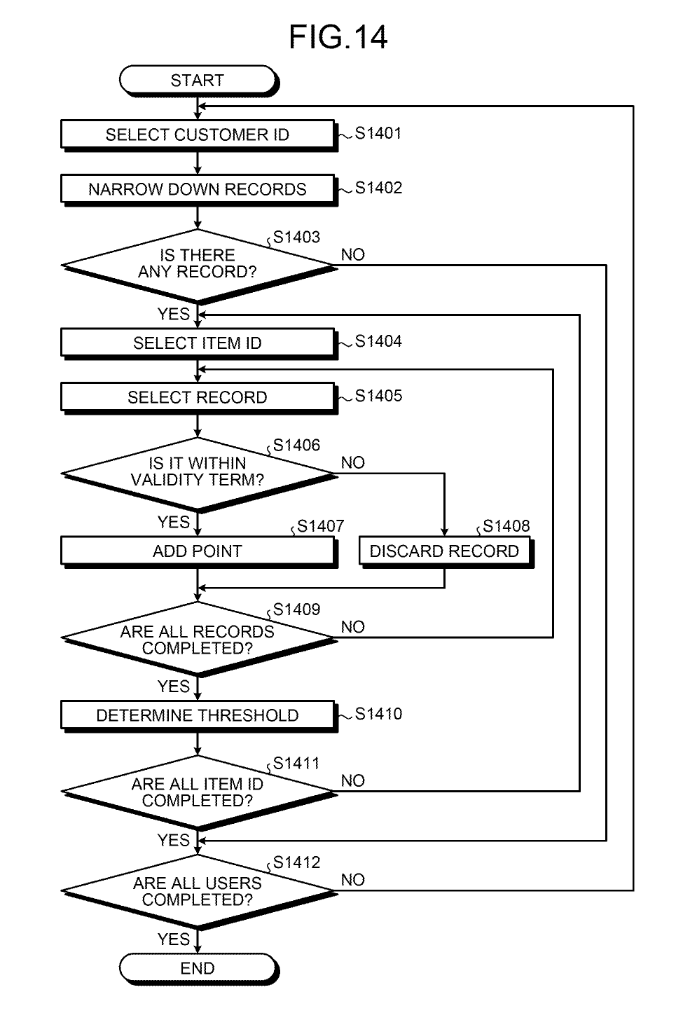

Described next is an analysis operation of act history information in the privilege management server 2 according to the present embodiment. FIG. 14 is a flowchart illustrating the detailed operation of the information analysis processing at S305 and S311 in FIG. 3. As illustrated in FIG. 14, the information analyzer 203 first selects one customer ID in order to select a user as an object whose information is analyzed (S1401). The selection of the customer ID at S1401 is the entire customer ID registered in the system for S305 in FIG. 3 and the customer ID that has been notified at S310 for S311.

The information analyzer 203 that has selected one customer ID narrows down the information of the act history DB 204 by the selected customer ID (S1402). As a result, when any record is extracted (Yes at S1403), the information analyzer 203 refers to “item ID” of the extracted record to select one “item ID” (S1404).

The information analyzer 203 that has selected one “item ID” selects one record having the selected “item ID” (S1405) and confirms the validity term of the record (S1406). At S1406, the information analyzer 203 refers to the point DB 205 illustrated in FIG. 10 based on the “act ID” of the selected record and acquires “point validity term” associated with the “act ID.” Based on the “act date and time” of the selected record and the acquired “point validity term,” the information analyzer 203 determines the timing when the point by the act is valid and checks whether the determination result is beyond the current date and time, thereby confirming the validity term of the record.

In the determination of the validity term at S1406, the information analyzer 203 calculates the differences between the dates and times of the timing when the respective records are valid and the current date and time and stores therein the differences as residual validity terms of the respective records in association with the respective records. The information analyzer 203 stores therein “point value” acquired from the information illustrated in FIG. 10 based on “act ID” of the respective records in association with the point values of the respective records. The residual validity terms and the point values of the respective records will be used in the later processing. The details will be described below.

As a result of the determination at S1406, if the record is within the validity term (Yes at S1406), the information analyzer 203 adds “point value” associated with its “act ID” in the point DB 205 (S1407). Thus, the information analyzer 203 quantifies the browsing acts on the shopping site by the users based on the act history stored in the act history DB 204, that is, browsing history information on the shopping site.

If the record is beyond the validity term (No at S1406), the information analyzer 203 discards the record (S1408). By thus performing refreshing processing that discards the record determined to have passed the validity term, the freshness of the information stored in the act history DB 204 can be maintained without performing any separate refreshing processing.

The information analyzer 203 that has completed the processing at S1407 or S1408 repeats the pieces of processing at S1405 and the subsequent steps on all the records having “item ID” selected at S1404 among the records narrowed down and extracted at S1402 (No at S1409). If the pieces of processing at S1405 and the subsequent steps on all the records having the specific “item ID” have been completed (Yes at S1409), the information analyzer 203 performs threshold determination on the point added with respect to the selected “item ID” (S1410).

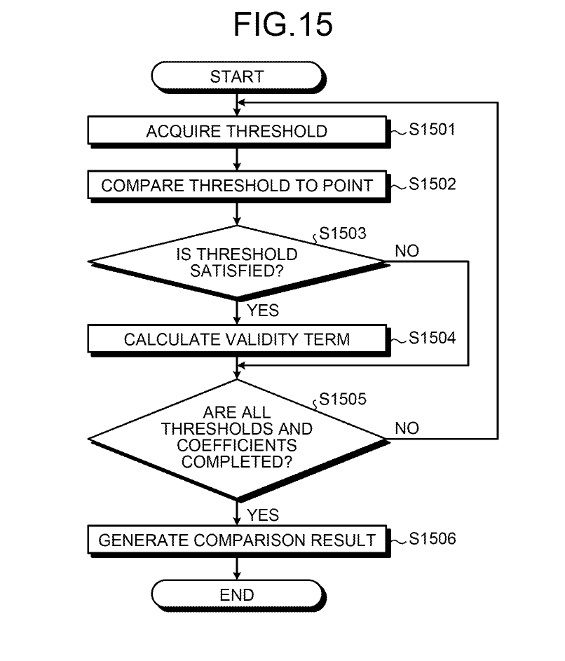

FIG. 15 is a flowchart illustrating the detailed operation of the information analyzer 203 at S1410. As illustrated in FIG. 15, the information analyzer 203 first acquires a threshold to be compared with the calculated point (S1501). At S1501, the information analyzer 203 refers to, for example, the information of the threshold DB 206 illustrated in FIG. 11 and acquires the “threshold” associated with the selected “item ID.”

When a threshold multiplied by a coefficient is acquired at S1501, the information analyzer 203 refers to the information of the coefficient DB 207 illustrated in FIG. 12 to acquire the coefficient associated with the selected “item ID.” The information analyzer 203 then multiplies the threshold that is already acquired by the acquired coefficient, thereby calculating and acquiring the threshold corresponding to the coefficient.

The information analyzer 203 that has thus acquired the threshold compares the acquired threshold with the added point (S1502). As a result of the comparison at S1502, if the threshold is satisfied (S1503), the information analyzer 203 stores therein the result and calculates and stores therein the validity term of a state satisfying the threshold (S1504).

At S1504, the information analyzer 203 refers to the residual validity terms of the records calculated at S1406 in FIG. 14 for the records having “item ID” selected at S1404 among the records extracted at S1402, and in ascending order, subtracts the above “point value” of the respective records from the point value calculated by repeating the processing at S1409. If the subtracted result falls short of the threshold acquired at S1501, the residual validity term of the record with which the subtracted “point value” is associated is acquired as a result of the processing at S1504.

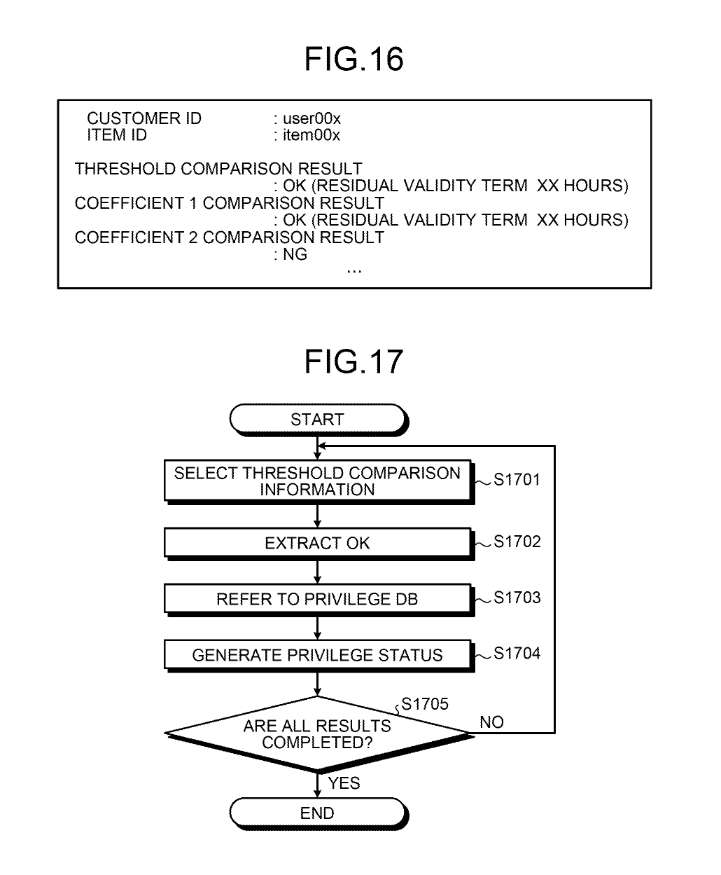

Upon completion of the pieces of processing up to S1504, the information analyzer 203 repeats the pieces of processing at S1501 and the subsequent steps on all the thresholds acquired from the threshold DB 206 and the thresholds acquired by multiplying by the coefficients acquired from the coefficient DB 207 (S1505), and upon completion of the pieces of processing at S1501 and the subsequent steps on all the thresholds and coefficients, generates information (hereinafter, referred to as “threshold comparison information”) as illustrated in FIG. 16 based on the respective comparison results and calculation results of the validity terms (S1506) to end the processing.

The threshold comparison information illustrated in FIG. 16 is information that describes comparison results with the threshold and thresholds multiplied by the respective coefficients for each combination of “customer ID” and “item ID.” In the threshold comparison information, if the comparison result is “OK,” that is, the browsing point satisfies the threshold, the validity term at that state calculated at S1504 is described in association therewith.

The information analyzer 203 that has completed the threshold determination at S1410 in FIG. 14 repeats the pieces of processing at S1404 and the subsequent steps on all “item ID” included in the record narrowed down and extracted at S1402 (No at S1411). Upon completion of the pieces of processing at S1404 and the subsequent steps on all “item ID” included in the record narrowed down and extracted, the information analyzer 203 repeats the pieces of processing at S1402 and the subsequent steps on all the selected users (No at S1412).

Upon completion of the pieces of processing at S1402 and the subsequent steps on all the selected users (Yes at S1412), the information analyzer 203 ends the processing. This processing completes the pieces of information analysis processing at S305 and S311 in FIG. 3 and generates the threshold comparison information as illustrated in FIG. 16.

At S305 in FIG. 3, the information analyzer 203 performs the operation illustrated in FIG. 14 on all the records stored in the act history DB 204. This processing causes the threshold comparison information illustrated in FIG. 16 to be generated for the combinations of all “customer ID” and all “item ID.” At S311 in FIG. 3, the information analyzer 203 generates the threshold comparison information illustrated in FIG. 16 only for the combinations of “customer ID” and “item ID” notified at S310 among the records stored in the act history DB 204.

Next, the updating processing on the privilege information at S306 and S312 in FIG. 3 will be described. FIG. 17 is a flowchart illustrating detailed operation in the privilege information updating processing. As illustrated in FIG. 17, the information analyzer 203 selects one piece of threshold comparison information as illustrated in FIG. 16 generated by the operation in FIG. 14 (S1701) and extracts a comparison result whose value is “OK” in the selected information (S1702). In the example in FIG. 16, “threshold comparison result” and “coefficient 1 comparison result” are extracted.

The information analyzer 203 that has extracted articles whose value is “OK” refers to the information of the privilege DB 208 illustrated in FIG. 13 to acquire “privilege contents” corresponding to the extracted articles (S1703). In the example in FIG. 16, for example, “threshold comparison result” and “coefficient 1 comparison result” are extracted, and “setting one aside” corresponding to “threshold” and “free delivery” corresponding to “threshold coefficient 1” are acquired.

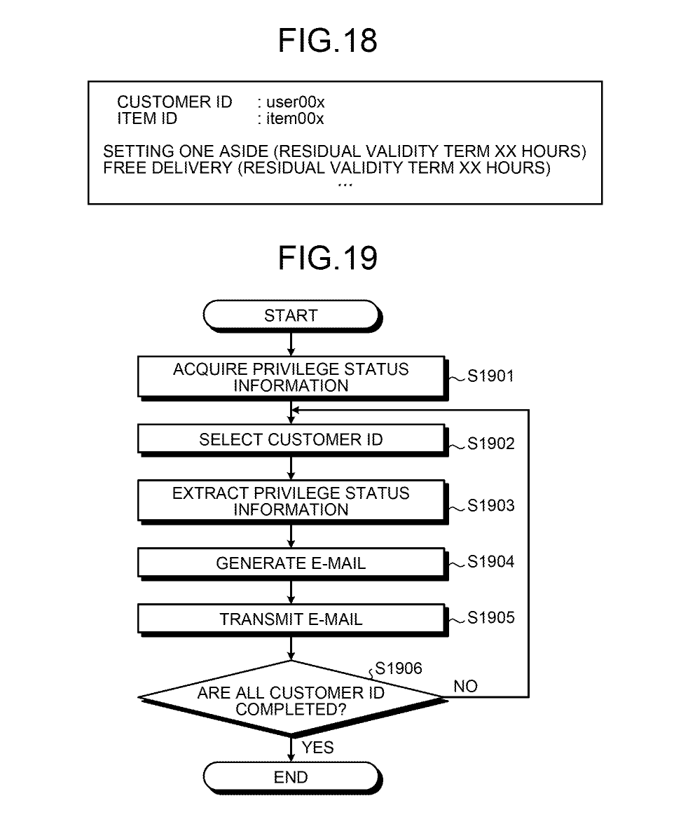

After thus extracting the information from the privilege DB 208, the information analyzer 203 converts the respective comparison results of the pieces of threshold comparison information as illustrated in FIG. 16 into the information on “privilege contents” acquired at S1703, thereby generating information as illustrated in FIG. 18 (S1704). The information illustrated in FIG. 18 is information (hereinafter referred to as “privilege status information”) described with the contents of privileges granted with respect to items identified by “item ID” the users identified by “customer ID” can receive and validity terms during which the privileges are granted. The notification of the privilege statuses at S307 and S313 is performed through the privilege status information illustrated in FIG. 18. In other words, at S1704, the information analyzer 203 functions as a notification information generator that generates information for notifying of privileges to be granted to the users based on the qualified browsing acts on the shopping site.

The privilege status information illustrated in FIG. 18 is, after being generated by the processing at S1704, stored in a storage medium in the privilege management server 2 and held therein. In this situation, information on the combination of the same “customer ID” and “item ID” is overwritten to be updated. This processing updates the privilege information. The privilege status information as illustrated in FIG. 18 is held in the privilege management server 2 while being updated, thereby enabling the shop server 1 and the PC 3 to check the latest privilege statuses by accessing the privilege management server 2.

Upon completion of the processing at S1704, the information analyzer 203 repeats the pieces of processing at S1701 and the subsequent steps on all pieces of selected threshold comparison information (No at S1705). Upon completion of the pieces of processing at S1701 and the subsequent steps on all pieces of selected threshold comparison information (Yes at S1705), the updating processing on the privilege information is ended. This operation performs updating processing on the privilege information at S306 and S312.

At S306 in FIG. 3, the pieces of threshold comparison information are generated for all the records stored in the act history DB 204, and the privilege status information illustrated in FIG. 18 is also generated for the combinations of all “customer ID” and all “item ID” in accordance therewith. At S312 in FIG. 3, the pieces of threshold comparison information are generated only for the combinations of “customer ID” and “item ID” notified at S310 among the records stored in the act history DB 204, and the privilege status information illustrated in FIG. 18 is also generated only for the combinations of “customer ID” and “item ID” notified at S310 in accordance therewith.

Described next with reference to FIG. 19 is a mode of notifying the users of the privilege statuses at S308 after the privilege status information illustrated in FIG. 18 is generated. As described above, at S306, the privilege status information illustrated in FIG. 18 is generated for the combinations of all “customer ID” and all “item ID” and is notified to the shop server 1 at S307.

The privilege-linked processor 102 of the shop server 1 acquires the privilege status information illustrated in FIG. 18 for the combinations of all “customer ID” and all “item ID” by the processing at S307 in FIG. 3 (S1901), selects one “customer ID” included in the acquired privilege status information (S1902), and extracts the privilege status information including the selected “customer ID” (S1903).

As described above, the privilege status information is generated for each combination of “customer ID” and “item ID,” and even for the same “customer ID,” the privilege status information may be generated based on combinations with different “item ID.” At S1903, all pieces of such privilege status information generated based on the combinations with different “item ID” with respect to the same “customer ID” are extracted.

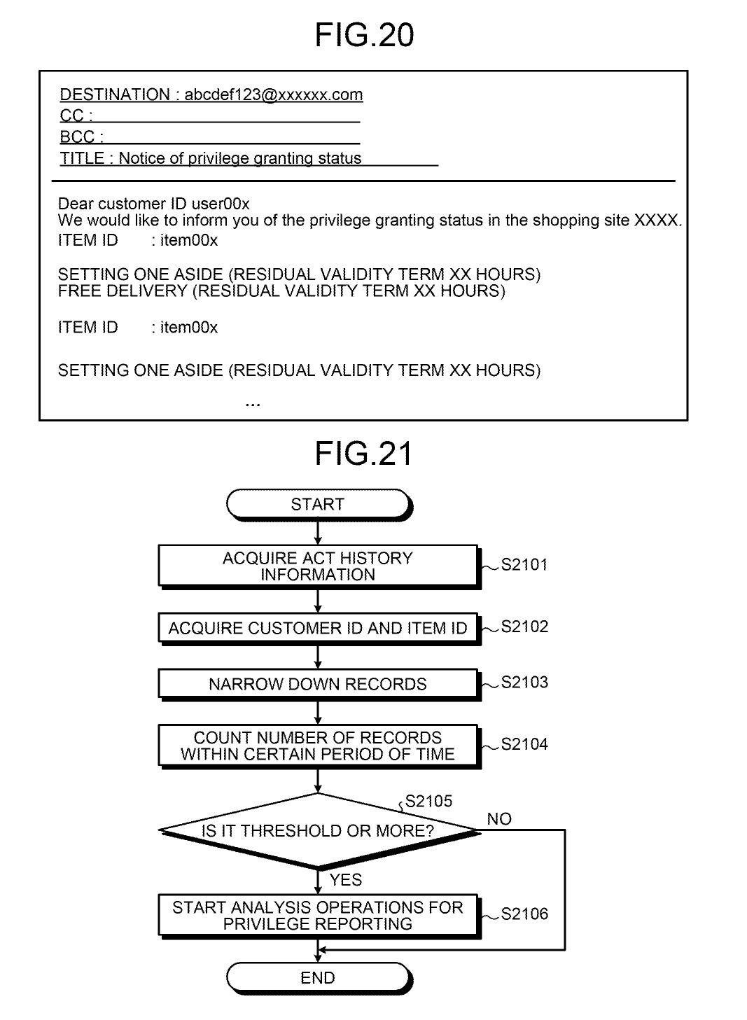

Upon completion of the processing at S1903, the privilege-linked processor 102 generates e-mails for notifying the respective users of the privilege statuses based on the extracted pieces of privilege status information (S1904). At S1904, the privilege-linked processor 102 refers to the customer DB 104 illustrated in FIG. 5 based on the selected customer ID, acquires the associated “e-mail address,” and sets it as a destination of an e-mail. Based on the extracted privilege status information, as illustrated in FIG. 20, e-mail body text is generated that describes the privilege contents and the residual validity terms to be granted to the respective items.

Upon generation of the e-mail for notifying of the privilege statuses as illustrated in FIG. 20, the privilege-linked processor 102 transmits the generated e-mail via the network I/F 110 (S1905). The privilege-linked processor 102 repeats the pieces of processing at S1902 and the subsequent steps on all the customer ID included in the acquired privilege status information (No at S1906), and upon completion of the pieces of processing at S1902 and the subsequent steps (Yes at S1906), ends the processing. This processing completes the privilege status notifying processing by e-mail transmission at S308.

Thus, the system according to the present embodiment notifies the respective users of the privilege statuses at any timing, and the eagerness to purchase of the users can be effectively promoted. The notification of the privilege whose validity term is set as described above is preferably performed at the timing when a user considers purchasing an item and hesitates to purchase it. Such timing can be achieved by causing the privilege management server 2 to align the pieces of timing when performing the operations at S305, S306, and S307 (hereinafter, referred to as “analysis operations for privilege notification”) in FIG. 3.

When a user hesitates to purchase, for example, it is considered that browsing acts for a specific item such as the browsing of images or the browsing of reviews related to an item the user considers purchasing are frequently performed. The privilege management server 2 starts an analysis operation for notifying of a privilege status based on such causes, thereby enabling the privilege status to be effectively notified. FIG. 21 is a flowchart illustrating the operation of such determination.

As described in FIG. 3, when a user performs a browsing act on the shopping site by operating the PC 3, the act history information is transmitted to the privilege management server 2 by the processing at S302, and the information receiver 201 acquires the information (S2101). The information receiver 201 updates the information of the act history DB 204 based on the acquired act history information, acquires “customer ID” and “item ID” included in the acquired act history information (S2102), and notifies of “customer ID” and “item ID” together with a request for the determination of browsing act frequency to the information analyzer 203.

The information analyzer 203 that has accepted the request for the determination of browsing act frequency narrows down the records of the act history DB 204 illustrated in FIG. 9 based on the notified “customer ID” and “item ID” (S2103) and counts the number of records whose “act date and time” is within a certain period of time among the extracted records (S2104). As a result of the counting, if the count is a preset threshold or more (Yes at S2105), the information analyzer 203 starts the analysis operations for privilege notification for “customer ID” and “item ID” notified at S2102 (S2106).

This processing performs the operations described in FIG. 14, FIG. 15, FIG. 17, and FIG. 19. In this case, at S1401 in FIG. 14, only “customer ID” notified at S2102 is selected, whereas at S1404, only “item ID” notified at S2102 is selected.

This processing notifies a user who considers purchasing an item and hesitates to purchase it of a privilege status, thereby enabling the sales promotion effect of privileges granted based on browsing acts to be increased. By thus granting privileges to the user who hesitates to purchase with a limited term as illustrated in FIG. 20, an effect of causing the user to make a decision on purchasing can be increased.

As described above, the system according to the present embodiment determines a privilege to be granted based on the history of browsing acts on the shopping site, thereby enabling sales promotion for customers who are highly likely to consider purchasing items.

The above embodiment describes a case, as an example, of calculating the period of time from the current date and time to the timing when the point is valid as “residual validity term” as illustrated in FIG. 16 and FIG. 18. However, this is an example, and it is only required that at least until when the respective privileges are valid is conveyed to the users. The date and time indicating the timing when the browsing point to satisfy the threshold expires may be indicated by “residual validity term until Xth day of Xth month X:X” for example.

The above embodiment describes a case, as an example, of notifying the users of the privilege statuses via e-mails. However, this is an example, and it is only required that at least the latest privilege status is conveyed to the users. For example, as illustrated in FIG. 21, when notifying with the browsing act of a user as a trigger, it is highly likely that the user is browsing the shopping site provided by the shop server 1 in real time. In view of this situation, when the privilege status information is notified by the processing at S307, the shop server 1 may display the privilege status on the shopping site without performing the e-mail transmission processing as illustrated in FIG. 19.

Specifically, upon acquisition of the privilege status information by the processing at S307, the privilege-linked processor 102 inputs the acquired privilege status information to the request responder 103. The request responder 103, when performing browsing response in response to the browsing request accepted by the request receiver, transmits information on a website on which the latest privilege information is displayed to the PC 3 based on the privilege status information input from the privilege-linked processor 102. This processing causes the PC 3 to display the latest privilege information on the shopping site and can notify of the privilege status in real time while the user is browsing the shopping site.

The above embodiment describes a case, as an example, of calculating the browsing point for each “customer ID” and “item ID” to determine privilege granting. When shopping, it is considered that different items of the same type are browsed while comparing them. In view of this situation, the browsing point may be calculated for each “customer ID” and “classification ID” illustrated in FIG. 6, not for each “customer ID” and “item ID,” to determine privilege granting. In this case, “classification ID” is used as the item identification information for identifying items.

This mode can be achieved in the same manner as the above by storing “classification ID” in association with the respective records in the information of the act history DB 204 illustrated in FIG. 9 and performing the selection of “classification ID” not the selection of “item ID” in the processing at S1404.

As described at S1408 in FIG. 14, the above embodiment describes a case, as an example, of discarding the expired record when expiration is determined in the information analysis operation. In addition, the refreshing operation of the act history DB 204, that is, operations to determine the validity terms of the records and discard expired records may be performed during midnight hours or the like, in which a load on the privilege management server 2 decreases. This processing excludes the expired records in advance in the operation in FIG. 14 and can reduce a processing load when performing the operation in FIG. 14.

As described in FIG. 11 and FIG. 12, the above embodiment describes a case, as an example, of setting in advance the thresholds to be applied to the browsing point in order to determine privilege granting and the coefficients that multiply the thresholds. In addition, for example, the threshold may be determined using an average of the browsing points calculated by the operation illustrated in FIG. 14. In this case, the information analyzer 203 functions as a threshold setting unit.

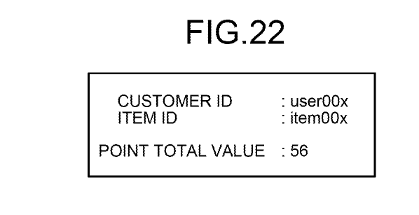

The information generated by the operation illustrated in FIG. 14 is the information as illustrated in FIG. 16, with the premise that “point total value” of the browsing points are calculated for each “customer ID” and “item ID” as illustrated in FIG. 22. Consequently, by totaling “point total value” of information having the same “item ID” and dividing it by the number of data, the average can be determined for each “item ID.”

As described in FIG. 3, the pieces of processing at S305 to S307 are performed on all pieces of information stored in the act history DB 204. Consequently, by performing the calculation operation of the average concurrently with the pieces of processing at S305 to S307, the average can be calculated for more “item ID,” and the information illustrated in FIG. 11 can be updated. The information of the coefficients illustrated in FIG. 12 can be determined based on the distribution of values or the maximum value of respective “point total values” totaled in the calculation of the average.

According to the embodiment described above, it is possible to enable sales promotion for customers who are highly likely to consider purchasing items in a service for selling items via network lines.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A privilege information processing system for managing privileges granted in an online shopping service that sells items via a network, the privilege information processing system comprising:
a browsing history information acquisition unit configured to acquire browsing history information on a website in the online shopping service;
an information analyzer configured to quantify a browsing act on the website by a user of the online shopping service based on the acquired browsing history information; and
a notification information generator configured to generate information for notifying of a privilege granted to the user in the online shopping service based on the quantified browsing act, wherein
the browsing history information includes user identification information for identifying a user of the online shopping service, item identification information for identifying an item sold in the online shopping service, and act identification information for identifying the type of the browsing act on the website, and
the information analyzer is configured to extract the browsing history information based on the user identification information and the item identification information included in the browsing history information, and quantify the browsing act on the website by referring to numerical value setting information set with a numerical value appropriate for the browsing act on the website based on the act identification information in the extracted browsing history information.

2. The privilege information processing system according to claim 1, wherein the notification information generator is configured to generate information for notifying of the privilege based on the quantified browsing act by referring to threshold information set with the privilege and a threshold for the numerical value as a condition for granting the privilege.

3. The privilege information processing system according to claim 2, wherein the threshold information is information set with different thresholds for a plurality of different privileges.

4. The privilege information processing system according to claim 2, further comprising a threshold setting unit configured to set the threshold for the numerical value based on an average of the quantified values.

5. The privilege information processing system according to claim 1, wherein
the numerical value setting information is information set with a validity term of the numerical value appropriate for the browsing act on the website,
the browsing history information includes act timing information indicating the timing of the browsing act on the website, and
the information analyzer is configured to quantify the browsing act on the website based on the browsing history information whose numerical value appropriate for the browsing act on the website identified by the act identification information is within a validity term based on the act timing information.

6. The privilege information processing system according to claim 5, wherein the notification information generator is configured to generate, based on the setting of the validity term of a numerical value appropriate for the browsing act on the website, information including information indicating the validity term of a privilege to be granted based on the quantified browsing act to notify of the privilege.

7. The privilege information processing system according to claim 1, wherein
the information analyzer is configured to quantify the browsing act when the browsing history information including the same user identification information and item identification information is acquired a certain number of times or more within a certain period of time, and
the notification information generator is configured to generate information for notifying of the privilege when the browsing act is quantified by the acquisition of the browsing history information including the same user identification information and item identification information a certain number of times or more within a certain period of time.

8. The privilege information processing system according to claim 7, further comprising a web page generator configured to generate a web page so that the privilege is notified on the web page in the online shopping service when the information for notifying of the privilege is generated.

9. A method for processing privilege information that manages privileges granted in an online shopping service that sells items via a network, the method comprising:
acquiring browsing history information on a website in the online shopping service as information comprising user identification information for identifying a user of the online shopping service, item identification information for identifying an item sold in the online shopping service, and act identification information for identifying the type of a browsing act on the website;
extracting the browsing history information based on the user identification information and the item identification information included in the acquired browsing history information;
quantifying the browsing act on the website by referring to numerical value setting information set with a numerical value appropriate for the browsing act on the website based on the act identification information in the extracted browsing history information; and
generating information for notifying of a privilege to be granted to the user in the online shopping service based on the quantified browsing act.

10. An information processing apparatus for managing privileges granted in an online shopping service that sells items via a network, the information processing apparatus comprising:
a browsing history information acquisition unit configured to acquire browsing history information on a website in the online shopping service;
an information analyzer configured to quantify a browsing act on the website by a user of the online shopping service based on the acquired browsing history information; and
a notification information generator configured to generate information for notifying of a privilege granted to the user in the online shopping service based on the quantified browsing act, wherein
the browsing history information includes user identification information for identifying a user of the online shopping service, item identification information for identifying an item sold in the online shopping service, and act identification information for identifying the type of the browsing act on the website, and
the information analyzer is configured to extract the browsing history information based on the user identification information and the item identification information included in the browsing history information, and quantify the browsing act on the website by referring to numerical value setting information set with a numerical value appropriate for the browsing act on the website based on the act identification information in the extracted browsing history information.
